(19) United States
(12) Patent Application Publication
(10) Pub. No.: US 2005/0012257 A1
(43) Pub. Date: Jan. 20, 2005

(54) Pry bar with rubber pivot

(76) Inventor: Aurelio A. Vigil, Miami, FL (US)

Correspondence Address: John H. Faro, Esq.;Faro & Associates, P.O. Box 4904, Key Biscayne, FL, 33149-4904, US

(21) Appl. No.: 10/821,600

(22) Filed: Apr. 9, 2004

Related U.S. Application Data
(60) Provisional application No. 60/461,200, filed on Apr. 9, 2003.

(51) Int. Cl. E05C 17/32

(52) U.S. Cl. 269/25

(57) ABSTRACT

An improved pry bar for prying a vehicle door out from its frame, thereby creating a gap there between of sufficient size to insert a long tool or rod into the vehicle in order to manipulate the interior door lock button, lever, or handle. One of the unique features of this improved pry bar is the mechanical detachable pivot or fulcrum which is composed of a rubber cushion. This pivot or fulcrum permit both the application of sufficient pressure upon the door to displace it relative to the frame and yet cushion the mechanical load on the door frame to prevent damage thereof during this operation.

### CROSS-REFERENCE TO RELATED PATENT APPLICATION

This application claims priority to Provisional Patent Application, Ser. No. 60/461,200, filed Apr. 9, 2003.

### BACKGROUND OF INVENTION

1. Field of the Invention

This invention relates to an article of manufacture. More specifically, this invention is directed to a tool suitable for use in Locksmithing. This tool is designed for gaining limited access to the interior of a vehicle by prying a vehicle door away from a door jamb, so as to permit manipulation of the vehicle's door lock or lock button, or door, handle with another tool (e.g. long rod) from within the vehicle.

2. Background of the Invention

In the field of Locksmithing, it is not uncommon to be called upon to unlock a vehicle door. Typically, such operation requires insertion of a so-called “slim jim” into the inner door cavity to manipulate the door lock linkage from within this cavity. This option has become increasingly unavailable because of protective measure made during vehicle manufacture to prevent unauthorized access to the locking mechanism from within the door's cavity.

Alternatively, access to the vehicle locking mechanism can be accomplished by some minimal displacement of the vehicle window (hard top model doors) or a vehicle door (sedan model doors) to allow for insertion of another tool into the vehicle to manipulate the door handle or vehicle locking mechanism from within the car. Such displacement of the vehicle window/door is generally accomplished by prying the vehicle's door or window out and away from the door jamb or frame (as the case may be), thereby creating working room sufficient to insert a long rod into the vehicle to manipulate the interior door lock button, lever, or handle.

As vehicle manufacturers have become increasingly aware of the potential for unauthorized vehicle access, the tolerances between the vehicle door/window and door jamb have been reduced, making it increasingly more difficult to gain access to the car interior by prying the door/window away from the door jamb. In those legitimate instances where access must be gained without aid of the vehicle door key, some unwarranted of damage is sustained in the process of prying the window away from the door frame—either as a result of the pry bar action upon the window, or upon the door jamb. The damage to the door jamb typically involves scratching or chipping of the paint and possible minor gouges and dents to the jamb itself. Notwithstanding, these limitations and known consequences of unlocking a vehicle door with the aid of a pry bar, the pry bar approach is and remains the preferred, and in a number of instances, the only technique available to the Locksmith to open a locked vehicle door without a key.

### OBJECTS OF INVENTION

It is the object to remedy the above as well as related deficiencies in the prior art.

More specifically, it is the principle object of this invention to provide an improved pry bar having a pivot or fulcrum designed to cushion the pry bar pressure upon the door jamb while unlocking an automobile door.

It is another object of this invention to provide an improved pry bar having a resilient elastomeric pivot or fulcrum that can be releasable affixed to a pry bar by mechanical means.

It is yet another object of this invention to provide an improved pry bar having a resilient elastomeric pivot or fulcrum that allows the insertion of a long narrow tool into the interior of the vehicle so as to permit the manipulation of the door lock button, door, lock lever, or door lock handle of a vehicle without the need to insert a wedge or other expedient between the door and the door jamb.

Additional objects of this invention include a method for the opening of a locked vehicle door with the improved pry bar of this invention.

### SUMMARY OF INVENTION

The above and related objects are achieved by providing a pry bar having a rigid shaft having a tapered tip, or reduced thickness, on one end thereof. This tapered tip includes a concave depression on the top-side of the pry bar, for insertion into the gap between the door and door frame. In the preferred embodiments of this invention, the pry bar of this invention includes a resilient pivot or fulcrum located on the underside of the rigid shaft proximate to the tapered tip. In one of the preferred embodiments of this invention, the resilient pivot or fulcrum is mechanically attached to the rigid shaft of the pry bar, thereby permitting its removal and replacement.

In use, the tapered tip of the pry bar is inserted into the gap between the door and door jamb, and pressure exerted upon the free end of pry bar end to displace the door frame relative to the door jamb. The length of the pry bar is a matter of choice depending upon the amount of physical force that need be applied to the pry bar to displace the door relative to the door frame. Thus, as the length of the pry bar is increased, the degree of leverage attained is increased, and the physical force that is needed to be exerted by the Locksmith is consequently reduced. In the preferred embodiments of this invention, the overall length of the pry bar is in the range of from about 12 to 24 inches. Typically, the door can be displaced and held at a distance from the door frame with one hand, while the Locksmith inserts a tool into the vehicle's interior. Alternatively, a wedge or comparable spacer can be inserted into the gap between door frame and the door jamb to maintain the gap between them. A long narrow tool can then be inserted through this gap into the interior of the vehicle, and the door locking mechanism manipulated from within the car, thereby unlocking the door.

In another of the preferred embodiments of this invention, the improved prior bar of this invention can be used to open a locked door of a vehicle by inserting the pry bar between the window glass and the door frame of door of the vehicle (hard top model). Essentially the same procedure is followed as described above relative to gaining access to the interior of the sedan model vehicle.

### BRIEF DESCRIPTION OF DRAWINGS

FIG. 1 illustrates a perspective view of a preferred embodiment of a pry bar of this invention.

FIG. 2 illustrates a perspective view of the preferred pry bar of this invention inserted into a door jamb of a sedan style motor vehicle.

FIG. 3 illustrates an enlarged view of the doorjamb of FIG. 2.

FIG. 4 is an enlarged view, in isolation, of the resilient pivot or fulcrum of the prior bar of FIG. 1.

### DETAILED DESCRIPTION OF INVENTION INCLUDING PREFERRED EMBODIMENTS

The preferred embodiments of this invention are described hereinafter in reference to the foregoing drawings. For ease of expression and comprehension, elements and components of each of these drawings, which depict common elements, are assigned the same reference numeral.

FIG. 1 shows the one of the preferred embodiment of the improved pry bar (10) of this invention. The pry bar (10) depicted in FIG. 1 includes a rigid shaft (12) having a tapered tip (14), or a discrete area of reduced thickness on one end thereof. This tapered tip (14) includes a concave depression (16) on the top-side (18) of the pry bar, for insertion into the gap (FIG. 2, 20) between the door (FIG. 2, 22) and door frame (FIG. 2, 24). This pry bar (10) further includes a fulcrum or pivot (26) located on the underside (28) of the pry bar. In the embodiment of the invention depicted in FIG. 1, the fulcrum or pivot (26) is positioned proximate to the tapered tip (14) to achieve maximum mechanical leverage for prying the door (FIG. 2, 22) away from the door frame (FIG. 2, 24).

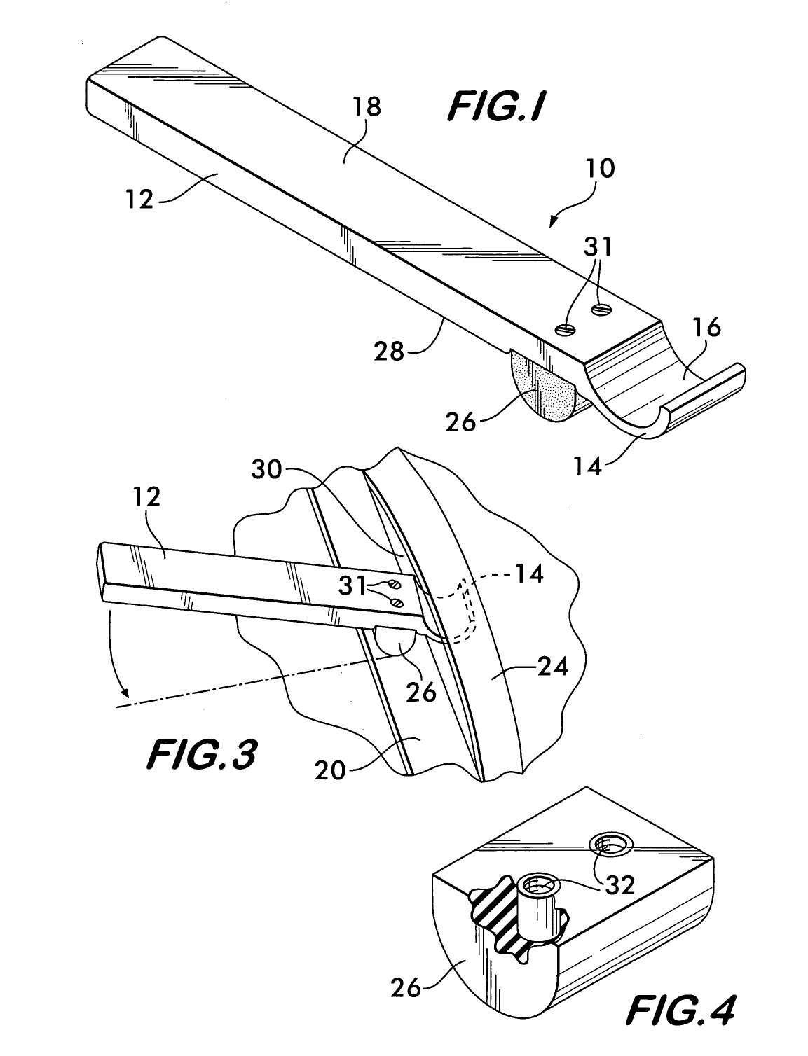

FIG. 2 illustrates one of techniques for use of the pry bar (10) of this invention. The pry bar (10) is depicted as inserted into the gap (20) between the door (22) and the door frame (24). The tapered tip (14) is inserted between the door weather stripping (25) and the door frame (24) and manual pressure/force thereupon applied to the opposite end of the pry bar. In the embodiment of this invention illustrated in FIG. 2, the pry bar can be manipulated with one hand, to create a gap (FIG. 3, 30) between the door (22) and the door frame (24). Thus, the Locksmith is free, with his other hand, to insert a lock mechanism manipulative tool through this gap (FIG. 3, 28) into the interior of the locked vehicle.

FIG. 3 illustrates the unique operation of the pry bar relative to the door and frame within the environment of contemplated use. More specifically, the pressure exerted upon the pry bar effectively displaces the door relative to the door frame without damage to the either the frame or to the door. In FIG. 3, the brunt of the pressure exerted upon door frame (24) is absorbed by the pivot or fulcrum (26) which cushions the force on the frame, and further prevents any abrasion of the frame.

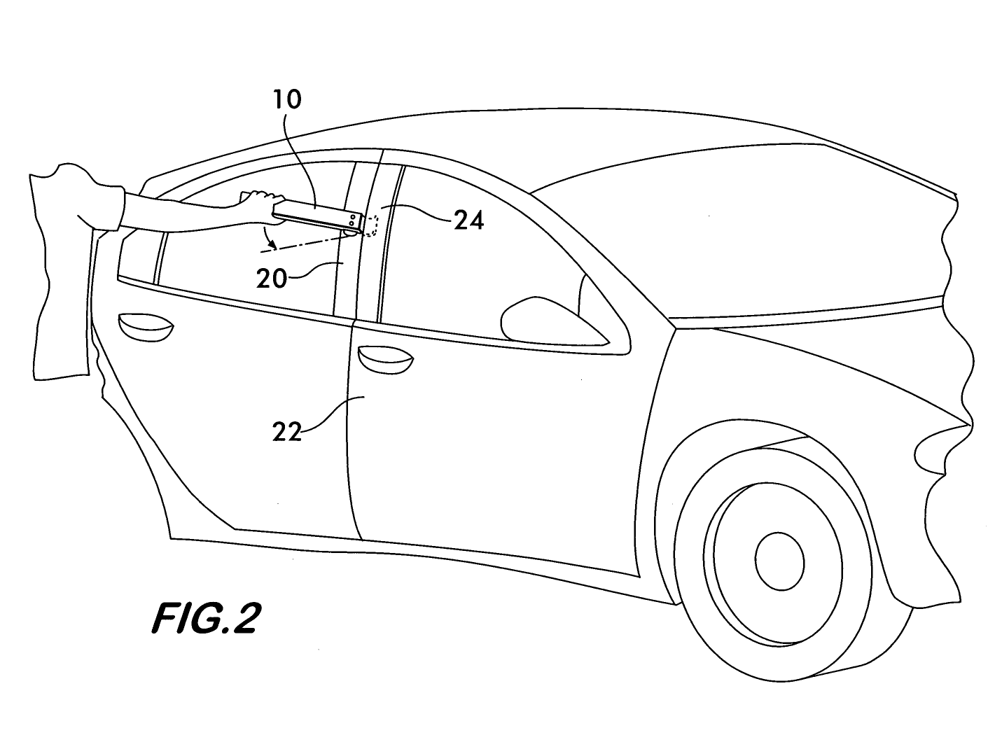

FIG. 4 illustrates in detail the physical parameters of a replaceable pivot or fulcrum contemplated for use in the improved pry bar of this invention. This replaceable pivot or cushion is composed of a durable natural or synthetic elastomeric compound have a durometer hardness sufficient to both support the lever action of the pry bar and yet be resilient enough to deform/flex under the contemplated loads that are applied to it during use. In one of the preferred embodiments of this invention, the pivot/fulcrum is composed a synthetic rubber compound (e.g. EPDM rubber compound) having a durometer hardness of approximately 80, and otherwise sufficiently mechanically durable enough to withstand the abuse of the commonly encountered by a Locksmith tool kit. The pivot/fulcrum is attached to the underside (28) of the rigid bar (12) with mechanical fasteners (31). More specifically, threaded inserts (32) embedded into the rubber compound which permits a companion fastener (31) to mechanically couple the pivot to the underside of the rigid bar.

It is to be understood, however, that the present invention may be embodied in various forms. Therefore, preferred embodiments disclosed herein are not to be interpreted as limiting, but rather as a basis for the claims and as a representative basis for teaching one skilled in the art to employ the present invention in virtually any appropriately detailed system, structure or manner.

Accordingly, the foregoing description of the preferred embodiments is not intended to limit the scope of the invention to the particular form set forth, but on the contrary, it is intended to cover such alternatives, modifications, and equivalents as may be included within the spirit and scope of the invention as defined by the appended claims.

1. In a tool kit for prying a vehicle door away from its door frame to gain limited access to the interior of the vehicle with a tool to manipulate the locking mechanism of the door and thereby unlock the door from the interior of said vehicle, wherein the improvement comprises:
a pry bar comprising a rigid shaft having a tapered tip, or reduced thickness, on one end thereof, said tapered tip including a concave depression on the top-side said pry bar, and a resilient pivot or fulcrum releasably affixed to the underside of the rigid shaft proximate to the tapered tip,
said resilient pivot or fulcrum comprising a resilient elastomeric material having both sufficient mechanical hardness to support said rigid shaft and thereby provide leverage pressure upon said door, yet cushion such leverage pressure upon said door frame, thereby preventing damage to said frame.

2. The tool kit of claim 1, wherein the resilient pivot or fulcrum is attached to said rigid shaft by a mechanical fasteners.

3. The tool kit of claim 1, wherein the pry bar comprises a hard rubber compound have reduced abrasion resistance to painted and glass surfaces.
